(19) United States
(12) Patent Application Publication
(10) Pub. No.: US 2007/0143277 A1
(43) Pub. Date: Jun. 21, 2007

(54) Content based partial download

(75) Inventors: Pierre Van De Laar, Eindhoven (NL); Christiaan Johannes Aarts, Geldrop (NL); Maarten Christiaan Pennings, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindoven (NL)

(21) Appl. No.: 10/579,157

(22) PCT Filed: Nov. 11, 2004
(86) PCT No.: PCT/IB04/52390

§ 371 Date: May 12, 2006

Related U.S. Application Data
(60) Provisional application No. 60/519,808, filed on Nov. 13, 2003.

(51) Int. Cl. G06F 17/30

(52) U.S. Cl. 707/5; 707/1; 707/10

(57) ABSTRACT

The present invention provides a system and method for storing a single file comprising multiple parts of content data and for selectively downloading at least one part thereof, including: the relevant files out of a zip-archive instead of the whole archive; a chapter instead of the whole book; the cover image out of an MP3 file; and the thumbnail of a jpg with exif header. The storing of various parts of data about an entity in a single file also provides the advantage of avoiding inconsistencies between the various parts. Often data and meta-data are combined in one file (this is already done to avoid inconsistencies between the parts). Examples in which this is currently done include: in one file have the whole image and its thumbnail; MP3 files already can contain an image of the CD cover together with the music; JPG files (with exif header) can contain meta-data (e.g. flash used, exposure) about the photograph. Preferably, a file is organized according to the present invention with a table of contents that describes the parts of the file in a way that enables partial download of the parts.

The present invention relates to storage of content in files to support content-based partial download and content-based partial download of information stored in files. More particularly, the present invention relates to a system and method for partial download of the contents of a file based on a context-of-use of the downloaded information.

Files for downloading often contain more information than a receiver wants. Downloading the entire file wastes both bandwidth and time. Many files already contain various artifacts that compactly represent other data contained in the file, e.g., metadata and content description data. However, currently there is no way to just download a specific part of a file.

Protocol exists that can download a file in parts. However, the downloaded file is only useful if all parts are downloaded. These existing protocols have one of the following limitation:
The parts have no relation to the content of the file. Hence the file is only usable after all parts are downloaded. Examples include in the realm of peer-to-peer (p2p) file exchange protocols and ftp or downloaded accelerators.
The content of the file has a sequential nature. An arbitrary set of parts is not used and only an uninterrupted initial part of the file is used. Examples include streaming audio and video, pdf files, and gif files.
   In both of the above cases the file is (in principle) downloaded completely.

Thus there is a need for a system and method providing a storage technique and corresponding download protocol that stores a plurality information items in files but only downloads a requested one or more items of information stored in the file.

The present invention provides a system and method for storing a single file comprising multiple parts of content data and for selectively downloading at least one part thereof, including:
the relevant files out of a zip-archive instead of the whole archive;
a chapter instead of the whole book, e.g., from a PDF file or MS® document;
one slide from a PowerPoint presentation;
the cover image out of an MP3 file; and
the thumbnail of a jpg with exif header.

The storing of various parts of data about an entity in a single file also provides the advantage of avoiding inconsistencies between the various parts. Often data and meta-data are combined in one file (this is already done to avoid inconsistencies between the parts). Examples in which this is currently done include:
in one file have the whole image and its thumbnail;
MP3 files already can contain an image of the CD cover together with the music.
JPG files (with exif header) can contain meta-data (e.g. flash used, exposure) about the photograph.
   Preferably, a file is organized according to the present invention with a navigational structure (e.g. a table of contents) that describes the parts of the file in a way that enables partial download of the parts. However, an embodiment of the present invention leverages existing techniques, such as extensible Markup Language (XML), which is well suited for subdividing a file based on content. Further, this embodiment is compatible with Microsoft files organized as structured storage objects and termed compound files: “a file system within a file”.

The advantages of the system and method of the present invention include the use of the same content system in different contexts-of-use and a system that is more robust in a changing usage environment, i.e., a system that is less vulnerable to changes over time.

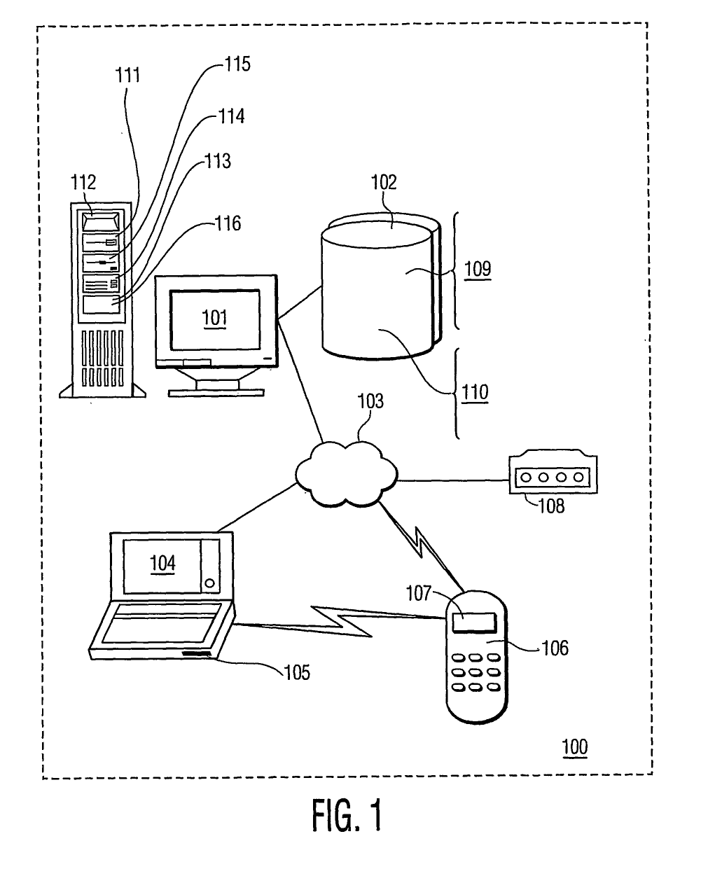

FIG. 1 illustrates both standalone and networked embodiments of the present invention;

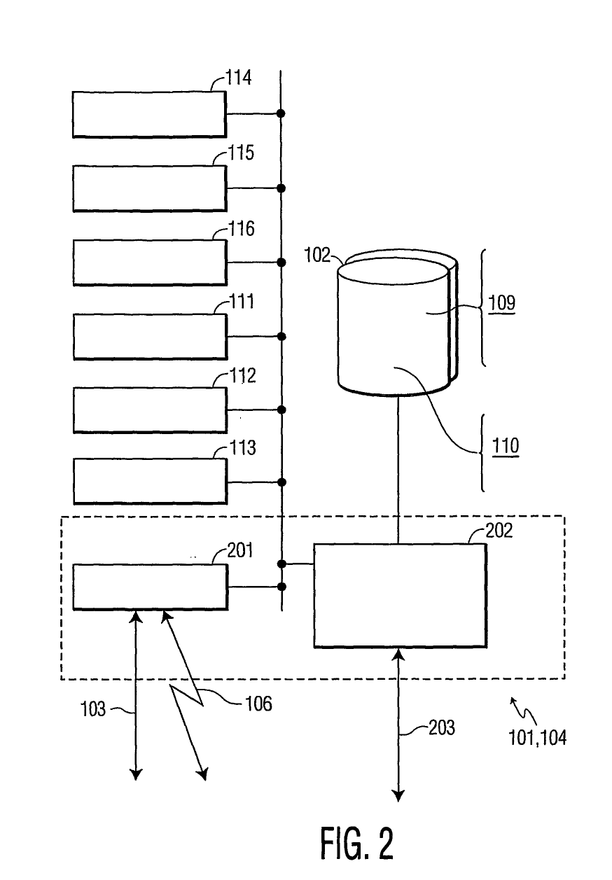

FIG. 2 is a simplified block diagram illustrating an architecture of a CE device whereto embodiments of the present invention are to be applied;

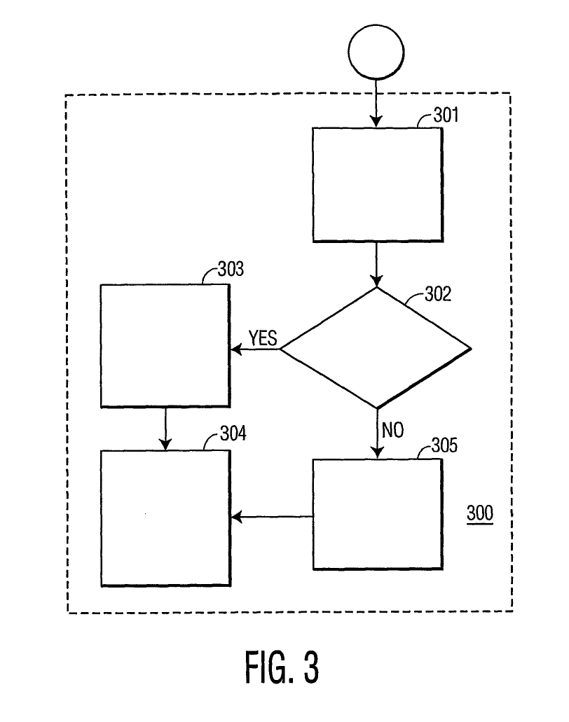

FIG. 3 illustrates creating a content based file, according to an embodiment of the present invention; and

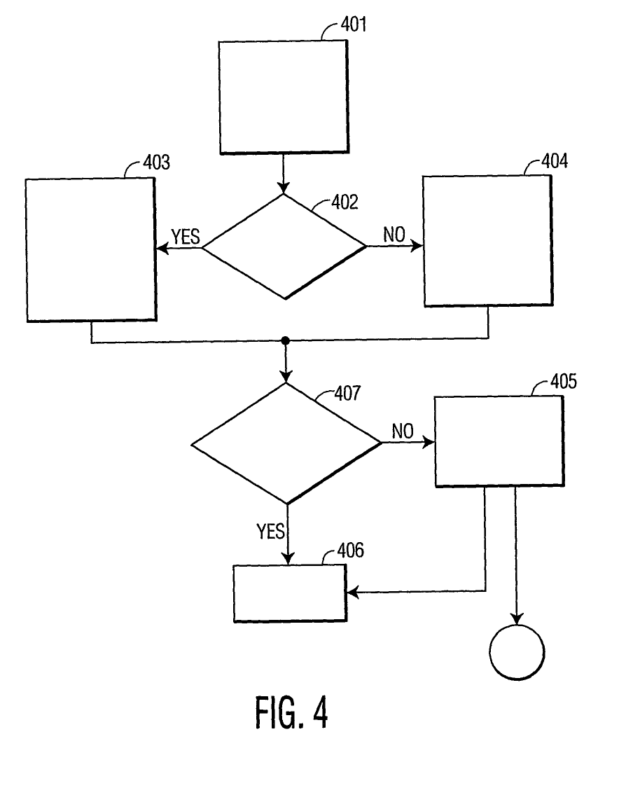

FIG. 4 illustrates processing a request for a partial download of a content based file, according to an embodiment of the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

FIG. 1 illustrates a representative configuration of a content server 101, having a DVD player 111, a CD player 112, a cassette player 113, and content repository 102 each being accessed for content-based partial downloads over a network 103 by a plurality (three in this example) different kinds of electronic devices: a laptop computer 104 with a DVD drive 105 for display of the synopsis of a movie, a mobile device 106 for download of a jpeg image of the performers of an MP3 song on a low resolution screen 107, and a consumer electronic device 108 for download of software to perform automatic self-diagnostics or provide interactive help to the user of the device. These combined content sources are a single content repository and are made to appear as a seamless whole to a requestor, in a preferred embodiment. One skilled in the art can envision how to accomplish removable. media access having the appearance of a repository file since such a feature is old in the art of database comprising multiple removable and fixed media.

As shown in FIG. 1, the content server 101 is coupled to the plurality of electronic devices 104-108, which, through wireline and wireless links, are communicating requests to the content server 101 for content-based partial downloads of various kinds from any of the content sources (DVD player 111, CD player 112, cassette player 113, and content repository 102). A key principle of the present invention is to provide a system and method to provide part of existing files or derivations thereof to each requesting electronic device, and, optionally to add any said derivations to the content repository 102 for servicing future requests. The content repository 102 comprises a content description 109 that contains a unique content ID, content type, content (storage) location, content size and other content attributes for all content contained in the repository as well as the content data 110 itself. In a preferred embodiment, the content repository 102 is implemented by a file system. The content data 110 can be stored in an existing standard format or in a preferred embodiment, as content data with appropriate embedded markers indicating such features as start and end of a section (e.g., a line or a chapter). Each individual entity stored in the content repository is a single file. In the case of updates corresponding to either replacements or derivations, it is well known in the art how to extend a file with additions so as to retain the appearance, i.e., functionality of a single file to users. That is, updates are transparent to requestors, in a preferred embodiment.

In a preferred embodiment, it is also possible for a requestor to directly access content on a removable device, e.g., the DVD drive 105 can be accessed by laptop computer 104 using the system and method of the present invention and by a Mobile Device 106 communicating with laptop computer 104 by wireline, e.g., a personal digital assistant, or wirelessly.

It should be noted that the network shown in FIG. 1 is small for purposes of illustration. In practice most networks would include a much larger number of content servers 101 and requesting devices 104-108.

The content server 101 may include a system with an architecture that is illustrated in the block diagram of FIG. 2. The content server 101 may include a transceiver 201 for receiving, demodulating and forwarding inputs of content and requests for content communicated by at least one of a network 103 and a wireless device 106, the transceiver 201 being coupled to an antenna (not shown). Alternatively, in a preferred embodiment requests and content can be received from a cable source 203. The transceiver 201 also provides modulation and transmission of content-based partial downloads communicated to at least one of a network 103 and a wireless device 106. The content server may contain at least one of an independent content source 111-113 and a content repository 102. Independent content sources include DVD 111, CD 112 and Cassette Drives 113, solid state devices. 114-116, video recorder-playback devices, which can host multiple sources, e.g., a carousel of removable content sources. Such a device supports removable media that conform to a set of known standards for identifying parts of a single content file contained therein.

As illustrated in FIG. 2, in operation a content repository interfaces to a content description or its equivalent for obtaining parts of identified content that are accessible via the content repository 102. In an alternative embodiment, the content location 109 that is part of the content description entry for each single content data file of the content repository, may be a proxy for the content, i.e., a universal resource locator for the actual multipart file. A proxy may be needed for very large files, copyrighted files, proprietary files, etc. Thus, in this embodiment the single content file is more like a virtual single content file than an actual physical single file because its data part is stored elsewhere and this virtual approach makes it possible for a content supplier to independently update content (e.g., stock quote, weather and news services) without any participation of the content server system 101. The user, however, of this virtual single content file is presented with a seamless view of the virtual file by the content-based partial download control logic module 202. In another alternative embodiment, the number of entries in the content description 109 is limited and there are embedded content markers that identify the type of content and its extent and these markers are actually in the content data 110 itself to delineate the parts thereof.

As shown in FIG. 2, the functionality of the content-based partial download is provided and controlled by the corresponding control logic module 202. This control logic module 202 may be software running on a general purpose PC, a dedicated logic circuit contained in a general purpose PC, or some other device that accomplishes the control of said functionality, which includes interfacing to a cable 203 for obtaining both content data by proxy and content data 110 for storing in the content repository 102 as well as for receiving requests for and responding with content-based partial downloads.

In a preferred embodiment a single file contains a plurality of parts, i.e., kinds, of data that can be selected and downloaded as a content-based partial download by a requestor. In a preferred embodiment, the download is termed a content-based partial download. That is, the actual download of parts of the file is coupled to the contents of the file. In a preferred embodiment, a content description is contained in the file (e.g. table of contents: or a content description) or a known (standardized) format is presumed given the file type and is the basis for the partial download. Hence, one can download
the lyrics of a particular track of a CD, while the server only stores one file for the whole CD;
the thumbnail part of the file without downloading the complete jpeg
the textual summary of a movie, while the server only stores one file containing a movie and its meta-data;
an image in a resolution suitable for the displaying device (low for mobile phone, high for PC) while the server stores multiple resolutions in only one file;
a single file from an archive file (e.g. zip); and
the last 30 seconds of a movie (typically the credits).
   All of these data are types of data that are related to an item, e.g.,
tracks of the data stored on a CD;
thumbnail image of a jpeg image;
text description of a video;
various resolution images of a subject;
one file of an archive;
any portion of a file, suitably defined.
   Most notably, the partial download data may already be anticipated and stored in the file, e.g., thumbnail of a jpeg image, or may have to be constructed from the data stored in the file, e.g., various resolution images of a subject or various encodings of tracks of a CD. And, the construction of the partial download may have to be done when the request is being satisfied, e.g., any portion of a file, suitably defined and/or delineated. In an alternative embodiment, any constructions can be optionally added to the file when storage is available. Additionally, this constructed data may replace the recipe for constructing this data where said recipe is part of the original file. Such additions are suitably described in the content description 109 for matching with future partial download requests.

Electronic consumer devices will be more and more network enabled and will provide a context-of-use for partial downloads. In an alternative embodiment, the context-of-use of a download determines what part of the stored information is partially downloaded. Suppose a file stores compact disc (CD) related information like the music (i.e. audio-streams), CD-cover (i.e., pictures), lyrics (i.e., simple text), etc. in the context-of-use of a CD-player, the music itself is considered to be the content to be downloaded. On the other hand, in the context-of-use of a Picture-viewer, the picture of the CD-cover is considered to be the data to be partially downloaded. Various products can provide such a context-of-use for a partial download.

Or, in another alterative embodiment, if the context-of-use is unknown, a user of an electronic consumer device (or a process running on an electronic device) can provide a context-of-use. This allows an electronic consumer device that has variable contexts-of-use to adapt partial downloads to its current context-of-use, e.g., the display of a mobile device used to display text messages, images of DVD covers, and thumbnails.

Finally, the principle of operation steps according to the present invention of creating, updating and accessing the content repository 102 downloads is explained hereafter.

Referring to FIG. 3, the inventive process for storing content data includes the following steps. In step 301, a content server 101 receiving one of a new content data or an update content data 110. In step 302 the content server 101 determining if the received content data is in a standard format that does not require a detailed content description entry. In step 303 finding an existing content ID or creating a new content ID for the received standard format input. In step 305, creating a new content description entry or finding and updating, if necessary, an existing content description entry for the received non standard format content data. And, in step 304, if not a proxy then storing the new or update content data and storing the location or proxy as the content location of the content description 109 entry for the content data.

Referring to FIG. 4, the inventive process for satisfying a request for a partial download of content data 102 includes the following steps. In step 401, receiving a request for a partial download, i.e., part of a content data 110 stored by a content server 101. In step 402, ascertaining if the requested content is stored in a standard format. If it is ascertained that the requested content data is stored in a standard format, in step 403, using content format knowledge to determine the location of the part rested. If it is ascertained that the requested content data is not store in a standard format, in step 404, determining the location of the part or a proxy therefore using the content description 109 of the content server's 101 content repository 102. In step 407, ascertaining if the requested part exists. If it is ascertained that the part exists, in step 406, either directly downloading the part from the local content data 110 or directing the proxy location to download the part to the requester. In step 405, if it is ascertained that the part does not exist, creating the part and sending the part to step 301 (A) and performing of one of creating and updating the content data as well as performing step 406 to download the requested part to the requester.

While the preferred embodiments of the present invention have been illustrated and described, it will be understood by those skilled in the art that various changes and modifications may be made, and equivalents may be substituted for elements thereof without departing from the true scope of the present invention. For example, other consumer electronic products that can host an embodiment of the present invention include any that can employ partial downloads in their operation, to direct their operation, or to diagnose their malfunction and direct corrective action using pre-stored, pre-formatted material. Examples include intelligent appliances having hierarchically organized help (parts of stored files selected by the user) for diagnosing problems and suggesting solutions, and hierarchically organized Help Files on a computing device (software module) with popups that optionally include audio and video clips, all of which can be organized as content-based partial downloads.

In addition, many modifications may be made to adapt to a particular situation and the teaching of the present invention can be adapted in ways that are equivalent without departing from its central scope. Therefore it is intended that the present invention not be limited to the particular embodiment disclosed as the best mode contemplated for carrying out the present invention, but that the present invention include all embodiments falling within the scope of the appended claims.

1. A method for content based partial download of a file, comprising the steps of:
a. receiving a request for a part of the file;
b. obtaining the requested part from the file; and
c. downloading the requested part.

2. The method of claim 1, wherein said obtaining step (b) further comprises the steps of:
b.1 determining whether the file has a standard format;
b.2 if the file has a standard format,
i. determining the location of the requested part from a content format knowledge of the standard format, otherwise,
ii. determining the location of the requested part from a content description of the file; and
b.3 if the requested part does not exist,
iii. creating the requested part otherwise,
iv. obtaining the requested part from the determined location.

3. The method of claim 1, wherein said obtaining step (b.) further comprises the step of
b.4 if the requested part does not exist, creating the requested part.

4. The method of claim 1, wherein:
said file further comprises at least one of
i. a standard content format, and
ii. a description component and a content component.

5. The method of claim 4, further comprising the steps of:
d. determining whether the file has a standard format;
e. if the file has a standard content format,
i. determining the location of the requested part from the standard content format, otherwise,
ii. determining the location of the requested part from the content description of the file;
f. determining if the requested part exists from the determined location; and
g. if the requested part does not exist, creating the requested part.

6. The method of claim 5, wherein said location is a proxy such as a universal resource locator (URL).

7. The method of claim 6 wherein said downloading step further comprises the step of downloading said requested part over a network.

8. The method of claim 1 wherein said downloading step further comprises the step of downloading said requested part over a network.

9. The method of claim 4, wherein:
said description component comprises at least one of a content identifier, a content type, a content location, a content size, a set at least one content attribute; and
said content component comprises content data and, optionally, at least one marker to demarcate a content part thereof.

10. The method of claim 4, wherein said standard format is based on at least one of extensible Markup Language (XML), Microsoft® structured storage object, compound documents, MP3, and JPG.

11. A method for creating and maintaining a content repository, comprising the steps of:
structuring the content repository to have a content description component and a content data component;
receiving one of new or update content data;
making an entry the content description component corresponding to the format of the received content data; and
storing the received content data in the content data component.

12. The method of claim 11, wherein:
said content description component comprises at least one of a content identifier, a content type, a content location, a content size, a set at least one content attribute; and
said content data component comprises content data and, optionally, at least one marker to demarcate a content part thereof.

13. A method of providing a partial download, comprising the steps of:
providing a content repository according to the method of claim 12; and
providing a partial download service according to the method of 1.

14. A method of providing a partial download, comprising the steps of:
providing a content repository according to the method of claim 12; and
providing a partial download service according to the method of claim 7.

15. A storage medium storing a content data repository, comprising:
the content repository having a content description component and a content data component;
an entry in the content description component corresponding to the format of a content data; and
an entry in the content data component of the content data corresponding to the content description entry in the content data component.

16. The method of claim 15, wherein:
said content description component comprises at least one of a content identifier, a content type, a content location of the corresponding content data entry in the content component, a content entry size, a set at least one content attribute; and
said content data component optionally further comprises at least one marker to demarcate a content part thereof.

17. A system for creating and maintaining a content based repository, comprising:
a receiver for receipt of a content data;
a storage medium configured as a database for storing said repository thereon, wherein said database comprises a content description component and a content data component a control logic module configured to
i. receive the content data
ii. one of create and update an entry in the content description component corresponding to a format of the received content data, and
iii. store the received content data in the content data component.

18. The method of claim 17, wherein:
said content description component comprises at least one of a content identifier, a content type, a location of the corresponding content data, a content size, a set at least one content attribute, and
said content data component comprises the content data and, optionally, at least one marker to demarcate a content part thereof.

19. The system of claim 18, wherein the format is a standard format based on at least one of extensible Markup Language (XML), Microsoft® structured storage object, compound document, MP3, and JPG.

20. A system for a content based partial download of a part of a file, comprising:
a transmitter for transmitting the content based partial download;
a control logic module configured to
i. obtain the part from the file; and
ii. download the obtained part via the transmitter.

21. The system of claim 20, wherein said control logic module is further configured to:
determining whether the file has a standard format;
if the file has a standard format,
iii. determine the location of the requested part from a content format knowledge of the standard format, otherwise,
iv. determine the location of the requested part from a content description of the file; and
if the requested part does not exist,
v. create the requested part, otherwise,
vi. obtain the requested part from the determined location.

22. The system of claim 20, wherein:
said file further comprises at least one of
iii. a standard content format, and
iv. a description component and a content component.

23. The system of claim 21, wherein:
said description component comprises at least one of a content identifier, a content type, a content location, a content size, a set at least one content attribute; and
said content component comprises content data and, optionally, at least one marker to demarcate a content part thereof.

24. The system of claim 20, wherein said location is a proxy such as a universal resource locator (URL).

25. The system of claim 20 wherein said downloading step further comprises the step of downloading said requested part over a network.

26. The method of claim 21, wherein said standard format is based on at least one of extensible Markup Language (XML), Microsoft® structured storage object, compound document, MP3, and JPG.

27. The system of claim 20 further comprising:
a receiver configured to receive a request for the content based partial download of the part of the file; and
wherein, said control logic module is further configured to obtain the requested part from the file.

28. A content based repository stored on a storage medium, comprising:
a content description component having at least one of a content identifier, a content type, a content location, a content size, a set at least one content attributes; and a content data component having a content data part and, optionally, at least one marker to demarcate a content part thereof.
